(19) United States
(12) Patent Application Publication
(10) Pub. No.: US 2009/0282358 A1
(43) Pub. Date: Nov. 12, 2009

(54) DISPLAY APPARATUS FOR DISPLAYING A WIDGET WINDOW AND A METHOD THEREOF

(75) Inventors: Da-hye PARK, Incheon (KR); Hyun-cheol PARK, Suwon-si (KR); Joon-kyu SEO, Seoul (KR); Hee-jeong BAE, Suwon-si (KR); Jong-chan PARK, Seoul (KR); Yoon-ji KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/263,634

(22) Filed: Nov. 3, 2008

(30) Foreign Application Priority Data
May 8, 2008 (KR) 10-2008-0042758

(51) Int. Cl. G06F 3/048

(52) U.S. Cl. 715/781

(57) ABSTRACT

A display apparatus for displaying a widget window and method thereof are provided. The display apparatus includes a generating unit which generates at least one widget window, a display unit which displays the least one widget window generated by the generating unit on a screen, and a control unit which changes a display pattern of the widget window, if a preset event occurs. Accordingly, the display patterns of widget windows are changed according to a user's preference, making it possible to increase the user's convenience.

### CROSS-REFERENCE TO RELATED APPLICATIONS

This application claims priority from Korean Patent Application No. 10-2008-0042758, filed on May 8, 2008 in the Korean Intellectual Property Office, the disclosure of which is incorporated herein by reference in its entirety.

### BACKGROUND OF THE INVENTION

1. Field of the Invention

Apparatuses and methods consistent with the present invention relate to displaying a widget window on display apparatus, and more particularly, to displaying a widget window in which a display pattern of a widget window can be changed in accordance with a user's preferences in an Internet Protocol television (IPTV) which is designed to be viewed.

2. Description of the Related Art

Recent developments in the field of computers and an increase in the resolution of computer monitors have led to monitors becoming larger. Accordingly, multitasking can be performed by performing operations in a predetermined portion of a monitor through a window by simultaneously running an application performing various functions such as widgets, in another portion of the monitor.

A widget or a gadget is a mini-program or application providing frequently used services in the form of icons and driving them separately, so contents can be received without opening a web browser, or various applications such as a clock can be driven separately.

In general, widgets based on a personal computer (PC) are fixedly disposed on a predetermined region of a screen, so the widgets always hide the predetermined region of the screen. Therefore, in an IPTV which is designed to be viewed, widgets based on the PC that continuously hide the predetermined region of the screen are not suitable.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a display apparatus for displaying a widget window in which a display pattern of a widget window can be changed in accordance with a user's preferences in an IPTV which is designed to be viewed, and a method thereof.

According to an aspect of the present invention, there is provided a display apparatus comprising a generating unit which generates at least one widget window, a display unit which displays the widget window generated by the generating unit on a screen, and a control unit which changes a display pattern of the widget window, if a preset event occurs.

The control unit may change the display pattern of the widget window so as not to hide a predetermined region of the screen.

The display apparatus may further comprise an input unit which receives user instructions for setting the event.

The display apparatus may further comprise a storage unit which stores the preset event and the display pattern of the widget window.

The generating unit may generate a plurality of widget windows, each having different validity periods, and the control unit may delete a widget window of which the validity period has been expired from the screen.

The preset event may be at least one of a first event in which the current time is included in a preset time slot, a second event in which a user account of the display apparatus is changed, a third event in which a type of main image displayed on the screen is changed, and a fourth event in which validity period for the current display state is terminated.

The display pattern may be at least one of the display location, size, layout, and color of the widget window.

According to another aspect of the present invention, there is provided a method of displaying a display apparatus comprising generating at least one widget window, displaying the generated widget window on a screen, and changing a display pattern of the widget window, if a preset event occurs.

The changing may comprise changing the display pattern of the widget window so as not to hide a predetermined region of the screen.

The method may further comprise receiving user instructions for setting the event.

The preset event and the display pattern of the widget window may be stored.

The generating may comprise generating a plurality of widget windows, each having different validity periods, and the changing may comprise deleting a widget window of which the validity period has been expired from the screen.

The preset event may be at least one of a first event in which the current time is included in a preset time slot, a second event in which a user account of the display apparatus is changed, a third event in which a type of main image displayed on the screen is changed, and a fourth event in which the validity period for the current display state is terminated.

The display pattern may be at least one of the display location, size, layout, and color of the widget window.

According to another aspect of the present invention, there is provided a display apparatus comprising an input unit which receives user instructions, and a control unit which changes a display pattern including at least one widget window to another display pattern according to the user instructions.

The display pattern may be at least one of the display location, size, layout, and color of the widget window.

The display apparatus may further comprise a storage unit which stores display patterns of a plurality of widget windows, wherein the control unit changes the displayed display pattern to a following display pattern whenever the user instructions are input.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view of a display apparatus displaying a widget window according to an exemplary embodiment of the present invention;

FIGS. 2A, 2B and 2C are views of one example of a display pattern of the widget window changing over time;

FIG. 3 is a view of one example of a display unit for a user setting;

FIGS. 4A and 4B are views of one example of a display unit for setting a type of TV program;

FIG. 5 is a view of one example of a display unit for setting a validity period;

FIG. 6 is a flow chart showing a display method displaying a widget window according to an exemplary embodiment of the present invention; and

FIG. 7 is a view of a display apparatus displaying a widget window according to another exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description such as, detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

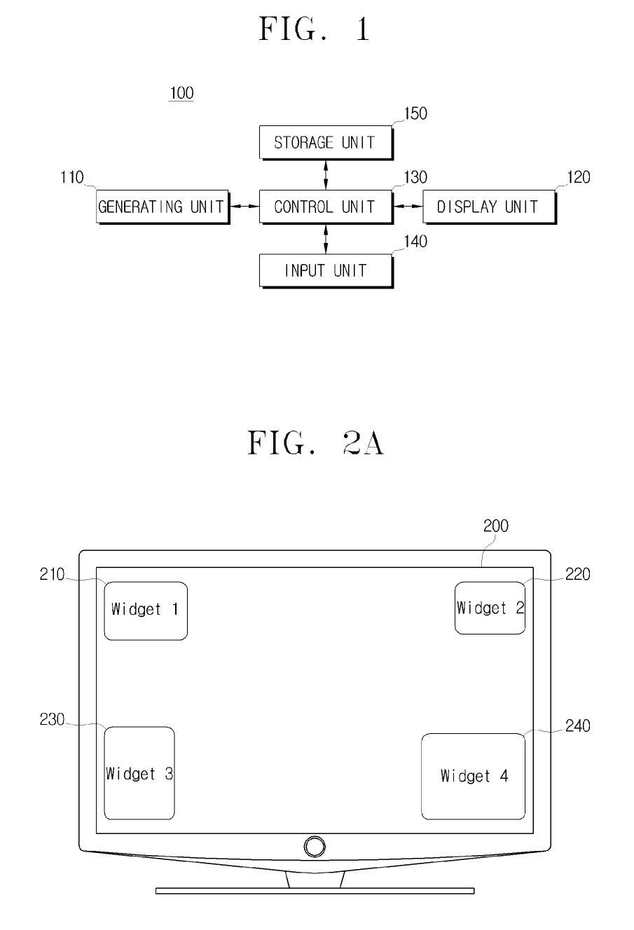

FIG. 1 is a view of a display apparatus displaying a widget window according to an exemplary embodiment of the present invention. Referring to FIG. 1, a display apparatus 100 which displays the widget window comprises a generating unit 110, a display unit 120, a control unit 130, an input unit 140, and a storage unit 150.

The generating unit 110 generates at least one widget window. As discussed above, a widget or gadget is a mini-program or application providing frequently used services in the form of icons and driving them separately, so the contents of services can be displayed through the widget window of a display screen. The display unit 120 displays the widget window generated by the generating unit 110 on the screen. The control unit 130 changes a display pattern of the widget window, if a preset event is occurs.

User instructions for setting an event may be input through the input unit 140. In this case, the input unit 140 may receive and input the user instructions for setting the event and changing the display pattern of the widget window to be different from the case having only the generating unit 110, the display unit 120, and the control unit 130.

Also, the display apparatus 100 which displays the widget window may further comprise a storage unit 150, wherein the storage unit 150 may store the preset event and the display pattern of the widget window.

Herein, the preset event may be at least one of a first event in which the current time is included in a preset time slot, a second event in which a user account of the display apparatus is changed, a third event in which a type of main image displayed on the screen is changed, and a fourth event in which a validity period for the current display state is terminated.

The display pattern may be at least one of a display location, size, layout, and color of the widget window.

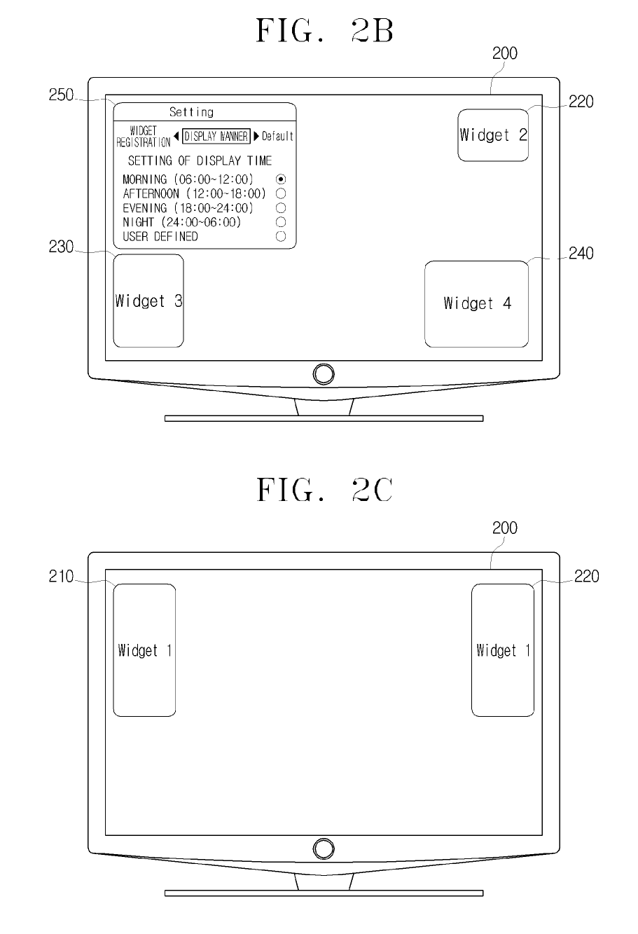

FIGS. 2A to 2C are views showing one example of a display pattern of the widget window changing over time. Referring to FIG. 2A, a plurality of widget windows 210, 220, 230, 240 may be displayed on a screen of a display unit 200.

If a certain button of a remote controller is pressed in order to change a general TV viewing mode not including a widget window to a widget mode, the plurality of widget windows 210, 220, 230, 240 are generated by the generating unit 110 and the generated widget windows 210, 220, 230, 240 are displayed on the screen, thereby changing to the widget mode.

If the storage unit 150 is set to display a display pattern of a predetermined widget window from 9:00 AM to 11:00 AM, the control unit 130 recognizes the occurrence of the first event when the current time becomes 9:00 AM, and controls the display pattern of the predetermined widget window stored in the storage unit 150 to be displayed. Thereby, the display pattern of the widget window disposed on the screen of the display unit 200 may be changed. The display pattern may be at least one of the display location, size, and color of the widget window.

When the user who views the display apparatus changes, in other words, when a second event occurs, the display pattern may also change. The user may log into his or her account in order to view an IPTV. Also, the display pattern may be different according to a user's preferences. For example, user A may prefer the widget windows to be disposed on each corner of the screen, and user B may prefer the widget windows to be aligned on one side of the screen. Accordingly, each user may pre-store his or her preferred display pattern in the storage unit 150. While user A is logging in, the control unit 130 controls the widget windows to be displayed on each corner of the screen. In this situation, if user B logs in, the control unit 130 recognizes the occurrence of the second event and controls the widget windows to be aligned on one side of the screen.

When the type of main image displayed on a screen of the IPTV changes, in other words, when a third event occurs, the display pattern may also changes. For example, in the case of news, a picture regarding the news may be displayed on the upper right-hand side of the screen. In order that the upper right-hand side is not hidden during broadcast of the news, the widget windows may be controlled to be displayed on portions of the screen other than the upper right-hand side. In the case of movies, subtitles may be displayed on a lower portion of the screen, so the widget windows may be displayed on only the remaining portions of the screen so as not to hide the lower portion of the screen. Therefore, the control unit 130 may display the widget windows on the portions of the screen other than the upper-hand right side, during the broadcast of the news, and may change the display pattern in order that the widget windows are displayed on the portions of the screen other than the lower of the screen only, when the type of main image is changed into movies, in other words, when the controller 130 recognizes the occurrence of the third event.

When a validity period of a predetermined widget window expires, in other words, when the control unit 130 recognizes the occurrence of a fourth event, the control unit 130 may change the display pattern in order that the widget window of which the validity period has been expired is deleted from the screen, and a default widget window or a preset widget window is displayed.

Referring to FIG. 2B, a user may input user instructions for setting a predetermined event using the input unit 140 of the display apparatus 100 which displays the widget window(s). FIG. 2B shows display patterns of widget windows which can be changed over time. The user may set a display time, such as morning, afternoon, evening, or night, using the input unit 140, and may set a user-defined display time to display a display pattern of a predetermined widget window during a predetermined time. In this case, the user may generally input the user instructions into the display apparatus using character keys, number keys, up, down, left or right direction keys, and an OK (selection) key of a remote controller, and/or a wheel key and an OK (selection) key of the input unit.

Even during the morning rush hour from 07:00 AM to 08:00 AM, the display unit may be set to display the display pattern of the predetermined widget window as shown in FIG. 2B. In this case, the user may obtain useful information from the plurality of widget windows 210, 220, 230, 240, while watching a morning drama. Widget window 210 may display traffic information on the route to the user's office, widget window 220 may display today's weather information, widget window 230 may display a clock, and widget window 240 may display scheduled information according to the user's day schedule pre-stored in a storage unit 150 while simultaneously displaying an alarm. The user may watch the morning drama with ease, while obtaining useful information from the plurality of widget windows 210, 220, 230, 240, by having the plurality of widget windows 210, 220, 230, 240 disposed on each corner of the screen.

Referring to FIG. 2C, the widget window 210 and the widget window 220 are included on the display screen of the display unit 120. If a user generally watches movies at night, the display apparatus may be set not to dispose the widget window 210 and the widget window 220 on the lower portion of the screen of the display apparatus. The disposition of the widget window 210 and the widget window 220 may also vary when the location of the subtitles changes. If the user wishes to display stock information while simultaneously watching a movie at night, the user may select the locations of the widget window 210 representing the Nasdaq Composite in a chart format and the widget window 220 representing the Dow Jones Composite Average in a chart format, in order to be minimally hindered while watching the movie.

FIG. 2B may provide a window 250 in which the plurality of widget windows 210, 220, 230, 240 are disposed in the same location as those in FIG. 2A and which receives the user's input in order to display the display pattern of the widget window for a predetermined time. In FIG. 2A, which shows a screen displayed during the morning, the display pattern of the widget windows 210, 220 as shown in FIG. 2C may be displayed, if the period classified as night begins.

In other words, although FIGS. 2A, 2B and 2C illustrate the case in which only the locations of the display patterns of the widget windows 210, 220, 230, 240 change, the size of the widget windows 210, 220, 230, 240 may change, the layout of the widget windows 210, 220, 230, 240 may change according to the user's preferences, and the color of the widget windows 210, 220, 230, 240 may also change to be transparent.

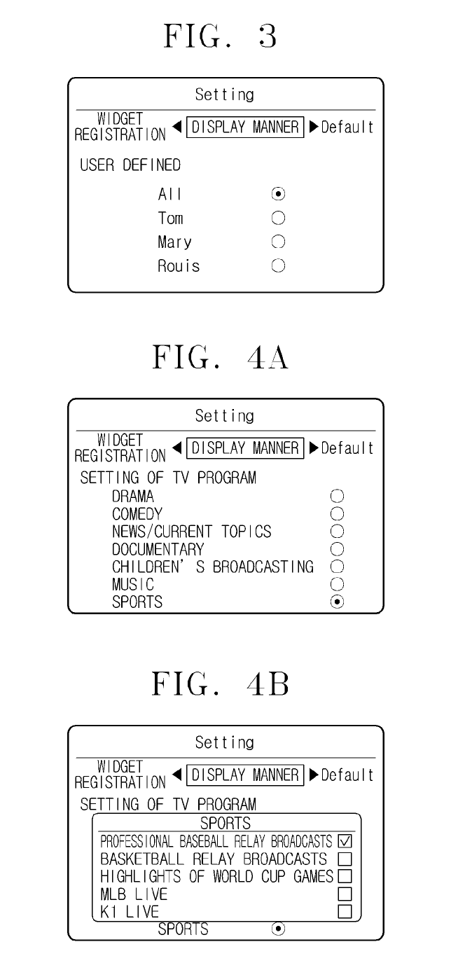

FIG. 3 is a view of one example of a display unit for a user setting. Referring to FIG. 3, different users may have different display patterns of various widget windows according to their preferences.

FIGS. 4A and 4B are views of one example of a display unit for setting a type of TV program. Referring to FIGS. 4A and 4B, the display patterns of various widget windows may be generated according to the type of TV program.

An IPTV may be generally provided with an Electronic Program Guide (EPG), from which TV genres such as drama, comedy or sports, may be selected according to the EPG, and a relay broadcast of professional baseball may be selected from among several sports as shown in FIG. 2B, when the sports is selected. When the relay broadcast of professional baseball is selected and viewed, scores are usually displayed on the upper right-hand side of the screen, so the display pattern of the widget window may be disposed so as not to hide the upper right-hand side of the screen.

A TV program may be selected using various methods, such as selecting the TV program after selecting a broadcaster, or selecting the TV program after selecting a day of the week.

FIG. 5 is a view of one example of a display unit for setting a validity period. Referring to FIG. 5, the validity period of a display pattern of a widget window to be displayed may be set. The validity period of each widget window may be set to be different from each other. In FIG. 5, a user may set the validity period to one day, one week, one month, or a user defined time period. When the validity period expires, the display pattern of the widget window may be terminated and deleted from the screen, and may then be changed to a display pattern of a default widget window or a preset widget window.

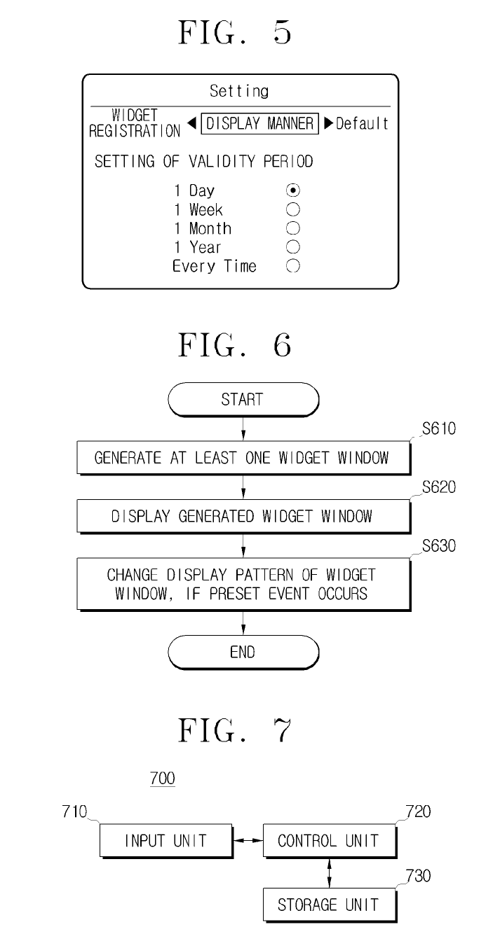

FIG. 6 is a flow chart showing a display method displaying a widget window according to an exemplary embodiment of the present invention. Referring to FIG. 6, a display method displaying a widget window comprises generating at least one widget window (S610), displaying the generated widget window on a screen (S620), and changing a display pattern of the widget window, if a preset event occurs (S630). Herein, the event may be a change of time slot, a change of user, a change of broadcast contents, or termination of the validity period.

FIG. 7 is a view of a display apparatus displaying a widget window according to another exemplary embodiment of the present invention. Referring to FIG. 7, a display apparatus 700 displaying the widget window includes an input unit 710, a control unit 720, and a storage unit 730.

The input unit 710 receives user instructions. The control unit 720 changes a display pattern including at least one widget window into another display pattern according to the user instructions. The storage unit 730 stores the display patterns of a plurality of widget windows.

In the storage unit 730, the display pattern of the plurality of widget windows are pre-stored, in which the display patterns of the plurality of widget windows differ in size, location, and/or layout of the widget window. For example, there may be various layouts such as a layout in which each widget window is disposed at each corner of a display screen, a layout in which the widget windows are aligned on a left-hand side of the display screen, a layout in which the widget windows each are aligned on upper and lower regions of the display screen, or a layout in which the widget windows are disposed in the center of the display screen.

The pre-stored display patterns may be sequentially changed to be displayed whenever a user inputs his or her instructions into the display apparatus using an OK (selection) key of an input unit such as a remote control. The user may thereby select a display pattern of a widget window among the display patterns of the plurality of widget windows according to his or her preferences.

As described above, according to exemplary embodiments of the present invention, the display patterns of widget windows change according to a user's preference, making it possible to increase the user's convenience.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
a generating unit which generates at least one widget window;
a display unit which displays the at least one widget window generated by the generating unit on a screen; and
a control unit which changes a display pattern of the at least one widget window, if a preset event occurs.

2. The apparatus as claimed in claim 1, wherein the control unit changes the display pattern of the at least one widget window so that a predetermined region of the screen is not hidden by the at least one widget window.

3. The apparatus as claimed in claim 1, further comprising:
an input unit through which user instructions for setting the preset event are input.

4. The apparatus as claimed in claim 1, further comprising:
a storage unit which stores the preset event and the display pattern of the at least one widget window.

5. The apparatus as claimed in claim 1, wherein the generating unit generates a plurality of widget windows, each having different validity period, and the control unit deletes from the screen a widget window of the plurality of windows if the validity period of the widget window has expired.

6. The apparatus as claimed in claim 1, wherein the preset event is at least one of a first event in which a current time is included in a preset time slot, a second event in which a user account of the display apparatus is changed, a third event in which a type of main image displayed on the screen is changed, and a fourth event in which a validity period for a current display state is terminated.

7. The apparatus as claimed in claim 1, wherein the display pattern is at least one of a display location of the at least one widget window, a size of the at least one widget window, a layout of the at least one widget window, and a color of the at least one widget window.

8. A method of displaying a display apparatus, the method comprising:
generating at least one widget window;
displaying the at least one widget window which is generated on a screen; and
changing a display pattern of the at least one widget window, if a preset event occurs.

9. The method as claimed in claim 8, wherein the changing comprises changing the display pattern of the at least one widget window so that a predetermined region of the screen is not hidden by the at least one widget window.

10. The method as claimed in claim 8, further comprising:
receiving user instructions for setting the preset event.

11. The method as claimed in claim 8, wherein the preset event and the display pattern of the at least one widget window are stored.

12. The method as claimed in claim 8, wherein the generating comprises generating a plurality of widget windows, each having different validity periods, and the changing comprises deleting from the screen a widget window of the plurality of windows if a validity period of the widget window has expired.

13. The method as claimed in claim 8, wherein the preset event is at least one of a first event in which a current time is included in a preset time slot, a second event in which a user account of the display apparatus is changed, a third event in which a type of main image displayed on the screen is changed, and a fourth event in which a validity period for a current display state is terminated.

14. The method as claimed in claim 8, wherein the display pattern is at least one of a display location of the at least one widget window, a size of the at least one widget window, a layout of the at least one widget window, and a color of the at least one widget window.

15. A display apparatus comprising
an input unit through which user instructions are input; and
a control unit which changes a display pattern including at least one widget window to another display pattern according to the user instructions.

16. The apparatus as claimed in claim 15, wherein the display pattern is at least one of a display location of the at least one widget window, a size of the at least one widget window, a layout of the at least one widget window, and a color of the at least one widget window.

17. The apparatus as claimed in claim 15, further comprising:
a storage unit which stores display patterns of a plurality of widget windows, wherein the control unit changes the displayed display pattern to a following display pattern if the user instructions are input.
